(19) United States
(12) Patent Application Publication
(10) Pub. No.: US 2014/0261802 A1
(43) Pub. Date: Sep. 18, 2014

(54) VACUUM ISOLATION DEVICE

(71) Applicant: BECQUEREL & SIEVERT CO., LTD., New Taipei City (TW)

(72) Inventor: CHI-KUANG CHEN, New Taipei City (TW)

(73) Assignee: BECQUEREL & SIEVERT CO., LTD., New Taipei City (TW)

(21) Appl. No.: 13/802,554

(22) Filed: Mar. 13, 2013

(51) Int. Cl. F16L 17/00

(52) U.S. Cl. CPC F16L 17/00
USPC 137/565.23

(57) ABSTRACT

A vacuum isolation device includes: a frame seat, at least one gas hole portion being formed thereon; a seal band set, configured on one side of the frame seat; a door plate element, mounted on the seal band set; and a vacuum generating device, connected with the gas hole portion, where a gas passageway is formed between seal bands, and the gas hole portion is in communication with the gas passageway. A vacuum state is formed in the gas passageway through the gas hole portion when the vacuum generating device is operated through the above structure, causing the door plate element to be attached onto the seal band set by means of vacuum operation while the vacuum generating device is operated. Thereupon, gas will be drawn out via the gas hole portion when it leaks from the inside or outside, thereby achieving the prevention of gas leak.

### (A) TECHNICAL FIELD OF THE INVENTION

The present invention relates to a vacuum isolation device, and more particularly to a vacuum isolation device for the prevention of gas leak.

### (B) DESCRIPTION OF THE PRIOR ART

Gas is a substance without a fixed form, capable of penetrating many tiny positions because of its characteristics, and therefore, requiring much attention and concern on control management so as to achieve gas isolation.

In the current world's highly developed technologies, various different fields, such as semiconductor, medical treatment, might utilize negative pressure space, in which a negative pressure state is formed through a vacuum generating device, thereby preventing outside gas from mixing with gas in a vacuum chamber body, and ensuring the quality of workpieces in the vacuum chamber body.

An opening for opening and closing a hermetical vacuum chamber body would be configured on one face of the vacuum chamber body; workpieces are placed in the vacuum chamber body via the opening, and a door plate element sealing the opening is combined together, thereby achieving the isolation of the inside from outside.

However, the conventional vacuum isolation devices mentioned above has the following problems and deficits indeed upon use:

In the conventional vacuum isolation device, outer join methods are mostly used to perform an action of allowing door plate elements to cover shielding an opening disposed on a vacuum chamber body, and buckling elements or other means are used to retain it. But, it only can retain and couple the door plate elements to the vacuum chamber body, but cannot ensure that gas does not leak.

### SUMMARY OF THE INVENTION

The main object of the present invention is to provide a vacuum isolation device, allowing a gas passageway to be formed between a seal band set and door plate element by configuring the seal band set on a frame seat and mounting the door plate element thereon, then keeping a negative pressure state in the gas passageway through a gas hole portion. Whereby, the issue existing in the conventional vacuum isolation devices that the door plate element is only fixed and covered on the opening of the vacuum chamber body but whether gas leaks or not cannot be ensured can be broke through, achieving the prevention of gas leak.

To obtain the above object, a vacuum isolation device according to the present invention includes: a frame seat; at least one gas hole portion, formed on one side of the frame seat: and an seal band set, configured on one side of the frame seat. The seal band set is adapted to allow a door plate element to be mounted thereon, a gas passageway is formed between the door plate element and the seal band set, and the gas hole portion is in communication with the gas passageway, where the gas hole portion is in connection with a vacuum generating device.

A vacuum negative-pressure state is formed in the gas passageway through the gas hole portion when the vacuum generating device is in action by means of the above structure, thereby allowing the door plate element to be attached and coupled onto the seal band set. Therefore, if gas leaks from the outside or inside, it enters the gas passageway, and will be drawn out by the vacuum generating device, achieving a protecting isolation effect, thereby to prevent the gas leak.

### BRIEF DESCRIPTION OF THE DRAWINGS

FIG. 1 is a perspective view of a preferred embodiment according to the present invention;

FIG. 2 is an exploded view of the embodiment according to the present invention;

FIG. 2A is a partly enlarged view of the embodiment according to the present invention;

FIG. 3 is a cross sectional view of the embodiment according to the present invention;

FIG. 4 is a perspective view of the embodiment according to the present invention in use;

FIG. 5 is another perspective view of the embodiment according to the present invention in use;

FIG. 6 is a schematic view of a preferred embodiment of a gas flow according to the present invention;

FIG. 7 is a perspective view of another preferred embodiment according to the present invention; and

FIG. 8 is a perspective view of another preferred embodiment according to the present invention in use.

### DETAILED DESCRIPTION OF THE PREFERRED EMBODIMENTS

Referring to FIGS. 1, 2, 2A and 3, which respectively are perspective, exploded, partly enlarged and cross sectional views of a preferred embodiment according to the present invention, a vacuum isolation device includes a frame seat 1, a seal band set 2. a door plate element 3, and a vacuum generating device

At least one gas hole portion 11 is formed on one side of the frame seat 1, and a first groove portion 12 and second groove portion 13 are configured on one side thereof, where the gas hole portion 11 is positioned between the first groove 12 and second groove portion 13.

The seal band set 2 is configured on one side of the frame seat 1, and includes a first seal band 21 and a second seal band 22, where the first seal band 21 is configured on the first groove portion 12, and the second seal band 22 the second groove portion 13.

The door plate element 3 is mounted on the seal band set 2, a gas passageway 5 is formed between the door plate element 3 and the seal band set 2, and the gas hole portion 11 is in communication with the gas passageway 5.

The vacuum generating device 4 is connected with the gas hole portion 11, a pressure sensing device 41 adapted to detect gas pressure is configured on the vacuum generating device 4, and the vacuum generating device 4 is operated jointly with the pressure sensing device 41.

Furthermore, the seal band set 2 is a hollow silicone gel band set or solid silicone gel band set. At least one handle set 31 allowing a user to grasp is configured on the door plate element 3. A connector connected with a flexible pipe is disposed on the gas hole portion 11, where one end of the flexible pipe is connected with the vacuum generating device 4.

Referring again to FIGS. 1, 2, 2A and 3, which respectively are perspective, exploded, partly enlarged and cross sectional views of a preferred embodiment according to the present invention, and FIGS. 4, 5 and 6, which respectively are a perspective view showing a use state, perspective view showing another use state, and schematic view showing gas flow of the embodiment according to the present invention, in the vacuum isolation device of the present invention, the frame seat 1 is first installed on a vacuum chamber body upon use, and the door plate element 3, on which the handle set 5 is configured, is then covered on it, the door plate element 3 can be taken off or detached down conveniently even if the door plate element 3 is disposed vertically. Thereafter, a gas passageway 5 is formed on the door plate element 3 inside the seal band set 2(between the first and second seal bands 21, 22). This structure and a gas operating way will be described in detail as the following: the space between the first and second seal bands 21, 22 is the gas passageway 5 for air flow when the door plate element is closed because the first and second seal bands are designed bulged, and the gas in the gas passageway 5 is drawn out through the vacuum generating device 4 via the gas hole portion 11 positioned between the first groove portion 12 and second groove portion 13; an adsorbing force will be yielded to the door plate element 3 to retain the door plate element 3 on the seal band set 2 when a negative pressure appears in the gas passageway 5. Furthermore, the pressure sensing device 41 of the vacuum generating device 4 will detect the pressure condition; the pressure sensing device 41 will command the vacuum generating device 4 to stop operation when a definite negative pressure is reached, causing the vacuum generating device 4 to stop gas drawing, and the pressure sensing device 41 will command the vacuum generating device 4 to carry out operation when the vacuum level in the gas passageway 5 decreases slowly to a threshold value after a period of time, causing the vacuum level in the gas passageway 5 to increase again. Thereupon, the power can be saved and the use of the vacuum generating device 4 extended effectively. Gas will be drawn out to avoid mixing of the gas inside and outside through the gas hole portion 11 when the gas leaks from the inside to outside via the first seak babd 21 or penetrate from the outside to inside via the second seal band 22 by means of the disposition of the gas hole portion 11 between the first groove portion 12 and second groove portion 12, Therefore, the gase laking can be avoided by means of the structure and acting way mentioned above.

Referring to FIGS. 7 and 8, which respectively are a perspective view of another preferred embodiment according to the present invention and a perspective view thereof in use, the embodiment adopts the conceptive theory of the present invention to use on a larger location; the operation way and gas expelling principle thereof all are the same as the above-mentioned, they are herein omitted. The present invention can be use in a medication centers or research units (e.g. negative-pressure care units, semiconductor production lines or high-precision biotech research and development laboratory) the matching of a large door plate element 3a with a large frame seat 1a. Obviously, this structure can be utilized in many fields, and the advantages of the present invention can be brought into full play.

Therefore, the key points that a vacuum isolation device of the present invention can improve prior arts are:

Regardless the gas leaks from the first seal band 21 or second seal band 33, the leaking gas will first enter the gas passageway 5, and is then drawn out through the gas hole portion 11 by matching the gas hole portion 11 and seal band set 2 with the vacuum generating device 4, thereby achieving the prevention of gas leak.

The door plate element 3 can be attached and coupled onto the gas passageway 5 by means of the negative-pressure adsorption of the gas passageway 5 without the necessity to add a structure coupling the door plate element 3 to the frame seat 1, thereby reducing the equipment cost.

I claim:

1. A vacuum isolation device, comprising:
a frame seat, at least one gas hole portion being formed thereon;
a seal band set, configured on one side of said frame seat;
a door plate element, mounted on said seal band set, a gas passageway being formed between said door plate element and said seal band set, and said gas hole portion being in communication with said gas passageway; and
a vacuum generating device, connected with said gas hole portion.

2. The vacuum isolation device according to claim 1, wherein said seal band set comprises a first seal band and second seal band.

3. The vacuum isolation device according to claim 2, wherein a first groove portion and second groove portion are configured on one side of said frame set, said first seal band and said second seal band are respectively installed on said first groove portion and second groove portion, and said gas hole portion is formed between said first groove and second groove portion.

4. The vacuum isolation device according to claim 1, wherein said seal band set is a hollow silicone gel band set or solid silicone band set.

5. The vacuum isolation device according to claim 1, wherein at least one handle for a user to grasp is configured on said door plate element.

6. The vacuum isolation device according to claim 1, wherein a connector is configured on said gas hole portion, a flexible pipe is configured on said connector, and one end of said flexible pipe is connected with said vacuum generating device.

7. The vacuum isolation device according to claim 1, wherein a pressure sensing device adapted to detect gas pressure is configured on said vacuum generating device, and said vacuum generating device is operated jointly with the pressure sensing device.
